(19) United States
(12) Patent Application Publication
(10) Pub. No.: US 2026/0246042 A1
(43) Pub. Date: Aug. 20, 2026

(54) SECONDARY BATTERY AND METHOD OF MANUFACTURING SAME

(71) Applicant: SAMSUNG SDI CO., LTD., Yongin-si (KR)

(72) Inventor: Dae Kyu KIM, Yongin-Si (KR)

(21) Appl. No.: 19/531,362

(22) Filed: Feb. 5, 2026

(30) Foreign Application Priority Data
Feb. 20, 2025 (KR) 10-2025-0022086

(51) Int. Cl. H01M 50/186; H01M 10/04; H01M 50/107; H01M 50/152; H01M 50/167; H01M 50/184; H01M 50/342

(52) U.S. Cl. CPC H01M 50/186; H01M 10/049; H01M 50/107; H01M 50/152; H01M 50/167; H01M 50/184; H01M 50/3425

(57) ABSTRACT

A secondary battery includes: an electrode assembly; a cylindrical case accommodating the electrode assembly, and including a bottom portion, a side wall portion connected to the bottom portion, and an opening portion opposite to the bottom portion; a cap assembly coupled to the opening portion of the case; and a gasket between the cap assembly and the case. The side wall portion includes a crimping portion bent radially inward to press and fix the cap assembly and the gasket, and an end of the crimping portion that is bent radially inward has a radius of curvature.

### CROSS-REFERENCE TO RELATED APPLICATION

The present application claims priority to and the benefit of Korean Patent Application No. 10-2025-0022086, filed on Feb. 20, 2025, in the Korean Intellectual Property Office, the entire disclosure of which is incorporated by reference herein.

### BACKGROUND

### 1. Field

Aspects of embodiments of the present disclosure relate to a secondary battery, and a method of manufacturing the secondary battery.

### 2. Description of Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the electrode assembly, and electrode terminals connected to the electrode assembly.

Cylindrical secondary batteries are widely used in various electronic devices due to having high energy density and excellent stability. A cylindrical secondary battery is designed to protect the battery by releasing an excessive pressure through a vent plate when an internal pressure increases due to a chemical reaction inside the battery. However, when the vent plate fails to function properly, the internal pressure continuously increases, which causes a battery explosion and potentially a thermal runaway. This may lead not only to a battery damage, but may also lead to a serious fire or explosion accidents.

The above information disclosed in this Background section is for the enhancement of understanding of the background of the present disclosure, and therefore, it may contain information that does not constitute related (or prior) art.

### SUMMARY

The present disclosure may be directed to a secondary battery having improved safety, and a method of manufacturing the secondary battery.

These and other aspects and features of the present disclosure will be described in, or will be apparent from, the following description of some embodiments of the present disclosure.

According to one or more embodiments of the present disclosure, a secondary battery includes: an electrode assembly; a cylindrical case accommodating the electrode assembly, and including a bottom portion, a side wall portion connected to the bottom portion, and an opening portion opposite to the bottom portion; a cap assembly coupled to the opening portion of the case; and a gasket between the cap assembly and the case. The side wall portion includes a crimping portion bent radially inward to press and fix the cap assembly and the gasket, and an end of the crimping portion that is bent radially inward has a radius of curvature.

In an embodiment, the gasket may include: a horizontal portion in contact with a top of the cap assembly; a vertical portion in contact with a side of the cap assembly; and a bent portion connecting the horizontal portion to the vertical portion. A position of the end of the crimping portion may correspond to a position where the bent portion and the horizontal portion contact each other with respect to a radial direction of the case.

In an embodiment, the gasket may include: a horizontal portion in contact with a top of the cap assembly; a vertical portion in contact with a side of the cap assembly; and a bent portion connecting the horizontal portion to the vertical portion. With respect to a radial direction of the case, the end of the crimping portion may be radially outward further than a position where the bent portion contacts the horizontal portion, and may be radially inward further than an inner circumferential surface of the vertical portion.

In an embodiment, an end portion of the gasket in contact with the crimping portion may be bent radially inward in response to the crimping portion being bent. A position of an end of the gasket may correspond to a position of the end of the crimping portion, or may be radially inward further than the end of the crimping portion.

In an embodiment, an end portion of the gasket in contact with the crimping portion may be bent radially inward in response to the crimping portion being bent, and a position of an end of the gasket may correspond to a position where the bent portion contacts the horizontal portion with respect to the radial direction.

In an embodiment, the side wall portion may further include: a beading portion under the crimping portion, and recessed radially inward to support the cap assembly and the gasket. The beading portion may protrude further radially inward than the end of the crimping portion.

In an embodiment, the cap assembly may include a vent plate.

In an embodiment, the cap assembly may include: a vent plate; and a cap-down under the vent plate.

In an embodiment, the cap assembly may include: a vent plate; a cap-down under the vent plate; and a cap-up at a top of the vent plate.

In an embodiment, a position of the end of the crimping portion may be configured to change from an inner side to an outer side in a radial direction in response to an internal pressure of the case exceeding a threshold pressure.

In an embodiment, the cap assembly may include a vent plate, and the threshold pressure may correspond to a rupture pressure of the vent plate.

In an embodiment, the threshold pressure may be 25 kgf/cm² or greater and 42 kgf/cm² or less.

In an embodiment, the side wall portion may include: a first cylindrical portion connected to the bottom portion; and a second cylindrical portion connected to the first cylindrical portion, and located at an end portion of the side wall portion. The crimping portion may be located in the second cylindrical portion, and a thickness of the second cylindrical portion may be greater than a thickness of the first cylindrical portion.

In an embodiment, a height of the second cylindrical portion may be 9% to 14% of a height of the side wall portion before the side wall portion is bent.

In an embodiment, a height of the second cylindrical portion may be 6.5 mm or greater and 9.0 mm or less before the side wall portion is bent.

In an embodiment, the radius of curvature of the end of the crimping portion may be less than 1.0 mm.

According to one or more embodiments of the present disclosure, a method for manufacturing a secondary battery includes: providing an electrode assembly; providing a cylindrical case including a bottom portion, a side wall portion connected to the bottom portion, and an opening portion opposite to the bottom portion; inserting the electrode assembly into the case; coupling a cap assembly to the opening portion of the case; and forming a crimping portion by bending the side wall portion radially inward. An end of the crimping portion is bent radially inward to have a radius of curvature.

In an embodiment, the coupling may include placing a gasket between the cap assembly and the case. An end portion of the gasket may be bent radially inward in response to the crimping portion being bent, and an end of the gasket may be disposed radially inward further than the end of the crimping portion.

In an embodiment, the gasket may include: a horizontal portion in contact with a top of the cap assembly; a vertical portion in contact with a side of the cap assembly; and a bent portion connecting the horizontal portion to the vertical portion. A position of the end of the crimping portion may correspond to a position where the bent portion contacts the horizontal portion with respect to a radial direction.

In an embodiment, a position of the end of the bent crimping portion may change from an inner side to an outer side in a radial direction in response to an internal pressure of the case exceeding a threshold pressure.

According to some embodiments of the present disclosure, as a length of a side wall portion of a case of a secondary battery case becomes smaller, a rupture pressure of a crimping portion may be designed to correspond to a rupture pressure of a vent plate. Accordingly, when gas is generated inside the case, and an internal pressure reaches the rupture pressure of the vent plate, the crimping portion and the vent plate may rupture together, thereby allowing the gas to be easily discharged.

According to some embodiments of the present disclosure, a rupture pressure of a crimping portion may be adjusted by reducing a length of an end portion of the crimping portion without affecting a sealing performance provided by a gasket.

According to some embodiments of the present disclosure, an end of a gasket may protrude further than an end of a crimping portion toward an inner side of a radial direction of a case, and thus, short circuits that may be caused by a contact between the end of the crimping portion and a cap assembly may be effectively prevented.

According to some embodiments of the present disclosure, as an end of a crimping portion extends in a direction parallel to a horizontal portion of a vent plate, even though an end of a gasket fails to protrude further than the end of the crimping portion toward an inner side of a radial direction of a case, a contact between the end of the crimping portion and a cap assembly may be prevented or substantially prevented.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF DRAWINGS

The above and other aspects and features of the present disclosure will be more clearly understood from the following detailed description of the illustrative, non-limiting embodiments with reference to the accompanying drawings, in which:

FIG. 1 is a cross-sectional view illustrating a secondary battery according to an embodiment of the present disclosure;

FIG. 2 is an enlarged cross-sectional view illustrating an example of a crimping portion of a secondary battery according to an embodiment of the present disclosure;

FIG. 3 is an enlarged cross-sectional view illustrating an example of a crimping portion of a secondary battery according to an embodiment of the present disclosure;

FIG. 4 is an enlarged cross-sectional view illustrating an example of a crimping portion of a secondary battery according to an embodiment of the present disclosure;

FIG. 5 is a cross-sectional view illustrating a secondary battery according to an embodiment of the present disclosure;

FIG. 6 is an enlarged cross-sectional view illustrating an example of a crimping portion of a secondary battery according to an embodiment of the present disclosure;

FIG. 7 is cross-sectional views illustrating a comparison of a crimping portion of a secondary battery according to an embodiment of the present disclosure and a crimping portion of a secondary battery according to a comparative example;

FIG. 8 is a schematic view illustrating a comparison of a case of a secondary battery according to an embodiment of the present disclosure and a case of a secondary battery according to a comparative example;

FIG. 9 is a schematic view illustrating a comparison of examples of discharging gas from a secondary battery according to an embodiment of the present disclosure and a secondary battery according to a comparative example; and

FIG. 10 is a flowchart illustrating a method for manufacturing a secondary battery according to an embodiment of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

Any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited herein is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, and the like as being “the same” as each other may mean that they are “substantially the same” as each other. Thus, the phrase “substantially the same” may include a case having a variation or a deviation that is considered low in the art, for example, such as a variation or a deviation of 5% or less. In addition, when a certain parameter is referred to as being uniform in a given region, it may mean that it is uniform in terms of an average.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

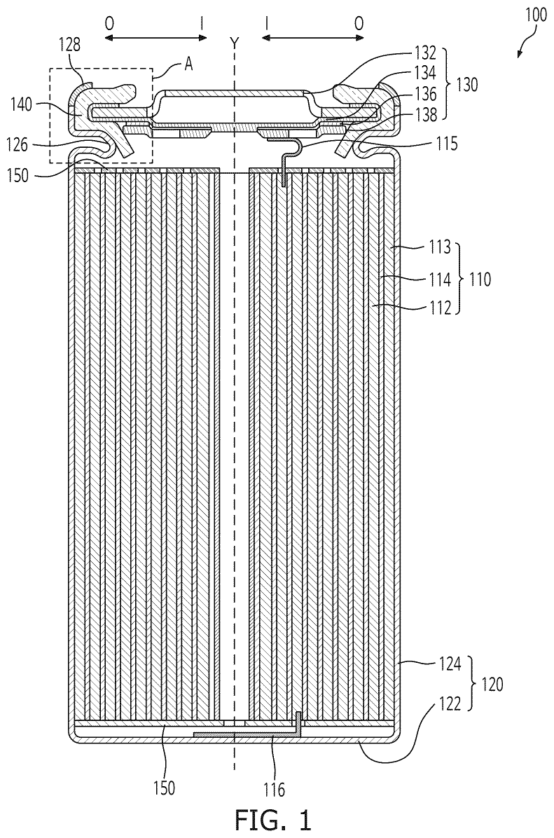

FIG. 1 is a cross-sectional view illustrating a secondary battery 100 according to an embodiment of the present disclosure.

Referring to FIG. 1, the secondary battery 100 may include an electrode assembly 110, a case 120 accommodating the electrode assembly 100, a cap assembly 130 sealing the case 120, a gasket 140 insulating the case 120 and the cap assembly 130 from each other, and an insulating plate 150 disposed between the electrode assembly 110 and the cap assembly 130.

The electrode assembly 110 may include a first electrode 112, a second electrode 113, and a separator 114 interposed between the first electrode 112 and the second electrode 113. The first electrode 112, the second electrode 113, and the separator 114 may be wound in a jelly-roll shape with respect to a winding axis Y.

The first electrode 112 may include a first substrate, and a first active material layer disposed on the first substrate. A first lead tab 115 may extend outward from a first non-coated portion of the first substrate where the first active material layer is not formed. The first lead tab 115 may be electrically connected to the cap assembly 130. The first non-coated portion may also be connected to a current collector plate. The current collector plate may be connected to the cap assembly 130 directly or through a separate lead tab.

The first electrode 112 may function as a positive electrode. In this case, the first substrate may include, for example, an aluminum foil, and the first active material layer may include, for example, a transition metal oxide.

The second electrode 113 may include a second substrate, and a second active material layer disposed on the second substrate. A second lead tab 116 may extend outward from a second non-coated portion of the second substrate where the second active material layer is not formed. The second lead tab 116 may be electrically connected to the case 120. For example, the second lead tab 116 may be welded to a bottom portion 122 of the case 120, but the present disclosure is not limited thereto. The second non-coated portion may also be connected to a current collector plate. The current collector plate may be connected to the case 120 directly or through a separate lead tab.

The first lead tab 115 and the second lead tab 116 may extend in opposite directions from each other. As another example, the first lead tab 115 and the second lead tab 116 may extend in the same direction as each other.

The second electrode 113 may function as a negative electrode. In this case, the second substrate may include, for example, a copper foil or a nickel foil, and the second active material layer may include, for example, graphite, silicon, and/or the like. However, the present disclosure is not limited thereto, and the first electrode 112 may function as a negative electrode, and the second electrode 113 may function as a positive electrode.

The separator 114 may allow the movement of lithium ions, and may prevent or substantially prevent a short circuit between the first electrode 112 and the second electrode 113. The separator 114 may include, for example, a polyethylene film, a polypropylene film, a polyethylene-polypropylene film, and/or the like.

The case 120 may accommodate the electrode assembly 110 and an electrolyte. The case 120 may include the bottom portion 122, a side wall portion 124 connected to the bottom portion 122, and an opening portion opposite to the bottom portion 122. The electrode assembly 110 may be inserted into the inside of the case 120 through the opening portion of the case 120. The case 120 may be approximately cylindrical, and may form the exterior of the secondary battery 100 with the cap assembly 130. The case 120 may include steel, steel alloys, aluminum, aluminum alloys, or equivalents thereof, but the present disclosure is not limited thereto.

The side wall portion 124 of the case 120 may include a beading portion 126 and a crimping portion 128. The beading portion 126 may be formed by the side wall portion 124 that is recessed toward an inner side I of a radial direction O-I of the case 120, and may support the cap assembly 130 and the gasket 140. For example, the beading portion 126 may suppress the movement of the electrode assembly 110 inside the case 120, and may facilitate the mounting of the gasket 140 and cap assembly 130. The crimping portion 128 may be formed by bending an end portion of the side wall portion 124 toward the inner side I of the radial direction O-I. The crimping portion 128 may firmly fix the cap assembly 130 by pressing against an edge of the cap assembly 130 through the gasket 140.

The cap assembly 130 may include a cap-up 132 having a plurality of through holes, a vent plate 134 disposed under the cap-up 132, an insulator 136 disposed under the vent plate 134, and a cap-down 138 disposed under the vent plate 134 and the insulator 136. The cap-down 138 may have a plurality of through holes, and may be electrically connected to the first lead tab 115. The central portion of the vent plate 134 may contact the cap-down 138, and an edge portion supported by the insulator 136 may be spaced apart from the cap-down 138. However, depending on the design, the components of the cap assembly 130 may be variously modified. For example, the cap-up 132 may be omitted from the structure of the cap assembly 130 as needed or desired. As another example, the cap-down 138 may be omitted as needed or desired, and the vent plate 134 may be directly connected to a lead tab or a current collector plate in a structure of the cap assembly 130.

A notch may be formed in the vent plate 134, which ruptures and releases gas when the internal pressure rises above a pressure (e.g., a predetermined or threshold pressure). For example, when gas is generated inside the case 120, and an abnormal internal pressure is formed, the gas may pass through the through-hole of the cap-down 138 and deform the shape of the vent plate 134, so that the vent plate 134 and the cap-down 138 may be electrically separated from each other. Subsequently, the vent plate 134 may rupture, and the gas may be released externally through the through-hole of the cap-up 132.

According to an embodiment, the gasket 140 may insulate the case 120 and the cap assembly 130 from each other. Additionally, the gasket 140 may be compressed between the beading portion 126 and the crimping portion 128 formed on the side wall portion 124 of the case 120, thereby sealing the case 120.

The insulating plate 150 may be disposed to contact the electrode assembly 110 under the beading portion 126. The insulating plate 150 may include a tab opening for withdrawing the first lead tab 115 therethrough. The cap assembly 130 electrically connected to the first electrode 112 through the first lead tab 115 may be disposed to face the electrode assembly 110 with the insulating plate 150 interposed therebetween, and may maintain an insulating state with the electrode assembly 110 by the insulating plate 150.

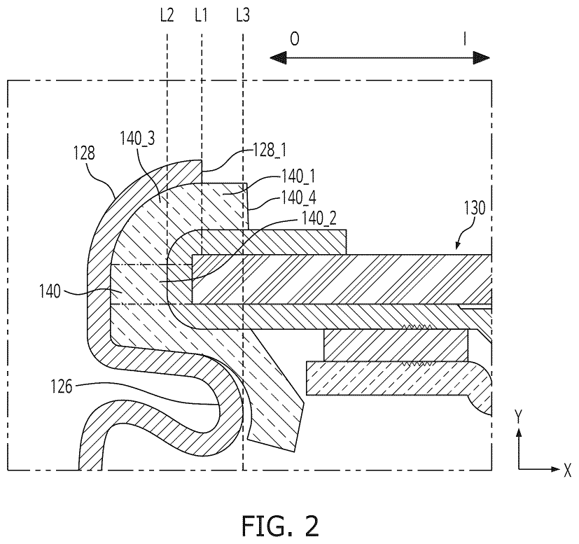

FIG. 2 is an enlarged cross-sectional view illustrating an example of a crimping portion of a secondary battery according to an embodiment of the present disclosure. FIG. 2 is an enlarged cross-sectional view of the area A of FIG. 1. Hereinafter, a direction toward the center of the case of the secondary battery is defined as an inner side I of a radial direction O-I of the case, and an opposite direction thereof is defined as an outer side O of the radial direction O-I of the case.

The case of the secondary battery may include a bottom portion, a side wall portion connected to the bottom portion, and an opening portion opposite to the bottom portion. The beading portion 126 and the crimping portion 128 for mounting the cap assembly 130 may be formed on the side wall portion of the case. The crimping portion 128 may be bent toward the inner side I of the radial direction O-I of the case to press-fit (e.g., press and fix) the cap assembly 130 and gasket 140.

According to an embodiment, an end 128_1 of the crimping portion 128 may be bent inward toward a center of the case. As the crimping portion 128 is bent, an end portion of the gasket 140 in contact with the crimping portion 128 may also be bent toward the inner side I in the radial direction O-I of the case. As the crimping portion 128 is bent, the gasket 140 may be closely attached to the cap assembly 130, thereby sealing the case.

According to an embodiment, the end 128_1 of the crimping portion 128 may be bent to have a radius of curvature (e.g., a predetermined radius of curvature). With respect to the cross-sectional view of the secondary battery taken along the vertical direction (e.g., the Y-axis direction), the end 128_1 of the crimping portion 128 may form part of a curve. In this case, the end 128_1 of the crimping portion 128 may be bent to have a single radius of curvature, but the present disclosure is not limited thereto. The radius of curvature of the end 128_1 of the crimping portion 128 may be less than 1.0 mm, but the present disclosure is not limited thereto.

According to an embodiment, the end 128_1 of the crimping portion 128 may be bent toward the inner side I of the radial direction O-I of the case. The end 128_1 of the crimping portion 128 may extend toward the radial direction O-I of the case, or in other words, in a direction parallel to or substantially parallel to the direction in which the cap assembly 130 extends (e.g., in the X-axis direction), but may form part of a curve having a radius of curvature.

According to an embodiment, the gasket 140 may include a horizontal portion 140_1 on or in contact with an edge of the top of the cap assembly 130, a vertical portion 140_2 on or in contact with the side of the cap assembly 130, and a bent portion 140_3 that connects the horizontal portion 140_1 and the vertical portion 140_2 to each other.

According to an embodiment, the position of the end 128_1 of the crimping portion 128 may correspond to a position L1 where the bent portion 140_3 and the horizontal portion 140_1 contact each other, based on the radial direction O-I of the case. In this case, the position of the end 128_1 of the crimping portion 128 may be located inwardly further than a position L2 of the inner circumferential surface of the vertical portion 140_2, based on the radial direction O-I of the case.

According to an embodiment, the beading portion 126 may be formed under the crimping portion 128, and may be recessed toward the inner side I of the radial direction O-I of the case. In this case, the beading portion 126 may protrude further than the end 128_1 of the crimping portion 128 toward the inner side I of the radial direction O-I of the case. The position of the end 128_1 of the crimping portion 128 may be located outward further than a position L3 of the inner circumferential surface of the beading portion 126 with respect to the radial direction O-I of the case.

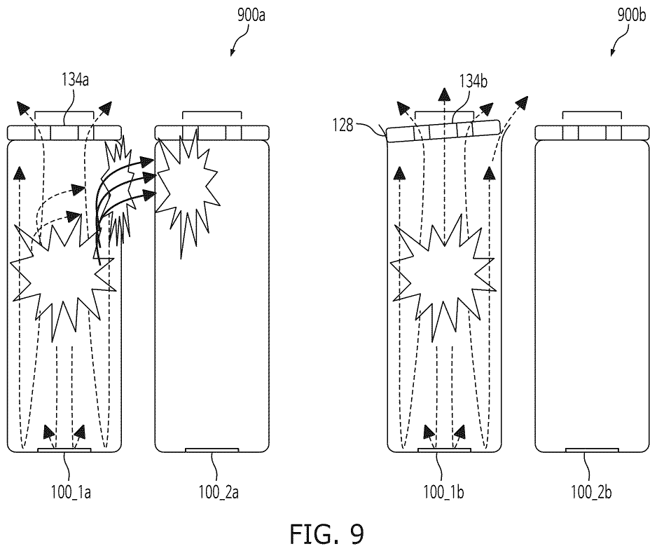

By adjusting the position of the end 128_1 of the crimping portion 128, a deformation pressure/rupture pressure of the crimping portion 128 may be controlled. For example, when the pressure inside the case exceeds a threshold pressure (e.g., a predetermined threshold pressure), the position of the end 128_1 of the crimping portion 128 may be deformed/changed from the inner side I to the outer side O in the radial direction O-I of the case due to the pressure inside the case. Accordingly, when gas is generated inside the case, the crimping portion 128 may be opened, so that the gas may be discharged through an opened gap. An example in which the crimping portion 128 opens and gas is discharged will be described in more detail below with reference to FIG. 9.

According to an embodiment, the deformation pressure/rupture pressure of the crimping portion 128 may correspond to or substantially correspond to the rupture pressure of the vent plate included in the cap assembly 130. Accordingly, when the internal pressure of the case reaches the rupture pressure of the vent plate, the crimping portion 128 may also deform/rupture, thereby facilitating a gas discharge. The deformation pressure/rupture pressure of the crimping portion 128 may be 25 kgf/cm² or greater and 42 kgf/cm² or less, but the present disclosure is not limited thereto.

According to an embodiment, the position of an end 140_4 of the gasket 140 may be located further toward the inner side I than the position of the end 128_1 of the crimping portion 128 with respect to the radial direction O-I of the case. The end 140_4 of the gasket 140 may protrude further toward the inner side I of the radial direction O-I of the case than the end 128_1 of the crimping portion 128. Accordingly, short circuits that may be caused by a contact between the end 128_1 of the crimping portion 128 and the cap assembly 130 may be effectively prevented.

FIG. 2 illustrates that the end 128_1 of the crimping portion 128 extends to the position L1 where the bent portion 140_3 and the horizontal portion 140_1 contact each other, but the present disclosure is not limited thereto. For example, the end 128_1 of the crimping portion 128 may extend further than the position L1 where the bent portion 140_3 and the horizontal portion 140_1 contact each other by maintaining a radius of curvature. As an example, when the end 128_1 of the crimping portion 128 extends from the position L1 toward the position L3, the end 128_1 of the crimping portion 128 may extend in a direction parallel to or substantially parallel to the direction of extension of the cap assembly 130 (e.g., the X-axis direction) and in a downward direction (e.g., −Y-axis direction) by maintaining a radius of curvature.

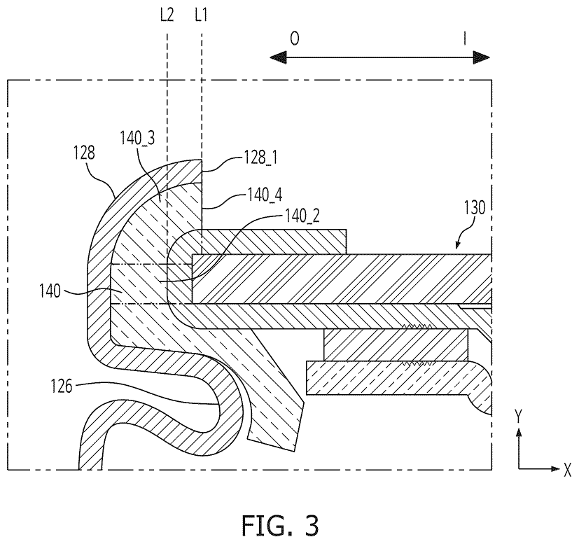

FIG. 3 is an enlarged cross-sectional view illustrating an example of a crimping portion 128 of a secondary battery according to an embodiment of the present disclosure. FIG. 3 is an enlarged cross-sectional view of the area A in FIG. 1. Hereinafter, the direction toward the center of the case of the secondary battery is defined as the inner side I of the radial direction O-I of the case, and the opposite direction thereof is defined as the outer side O of the radial direction O-I of the case. Hereinafter with reference to FIG. 3, redundant description of the components that are the same or substantially the same as those described above with reference to FIG. 2 may not be repeated.

According to an embodiment, the end 128_1 of the crimping portion 128 may be bent toward the inner side I of the radial direction O-I of the case. The end 128_1 of the crimping portion 128 may extend in the radial direction O-I of the case, or in other words, in a direction parallel to or substantially parallel to the direction of extension of the cap assembly 130 (e.g., the X-axis direction).

According to an embodiment, as the crimping portion 128 is bent, the end portion of the gasket 140 in contact with the crimping portion 128 may also be bent toward the inner side I of the radial direction O-I of the case. The gasket 140 may include a vertical portion 140_2 on or in contact with the side of the cap assembly 130, and a bent portion 140_3 that extends from the vertical portion 140_2. The gasket 140 shown in FIG. 3 may not include a horizontal portion (e.g., the horizontal portion 140_1) compared to the gasket shown in FIG. 2.

According to an embodiment, a position L1 of the end 128_1 of the crimping portion 128 may correspond to the position L1 of the end of the bent portion 140_3 with respect to the radial direction O-I of the case. The position of the end 140_4 of the gasket 140 may correspond to the position of the end 128_1 of the crimping portion 128 based on the radial direction O-I of the case. The position of the end 140_4 of the gasket 140 may be located further inward than the position L2 of the inner circumferential surface of the vertical portion 140_2.

The length of the gasket 140 may be smaller than that of the gasket 140 shown in FIG. 2. In more detail, with the positions of the end 128_1 of the crimping portion 128 and the end 140_4 of the gasket 140 corresponding to each other based on the radial direction O-I of the case, the gasket 140 may extend to (e.g., only to) an area where the gasket 140 contacts the crimping portion 128. The end 128_1 of the crimping portion 128 may not incline downward toward the cap assembly 130, and may extend toward the inner side I in the radial direction O-I of the case, which is parallel to or substantially parallel to the cap assembly 130. Therefore, even though the end 140_4 of the gasket 140 fails to protrude further than the end 128_1 of the crimping portion 128, a contact between the crimping portion 128 and the cap assembly 130 may be prevented.

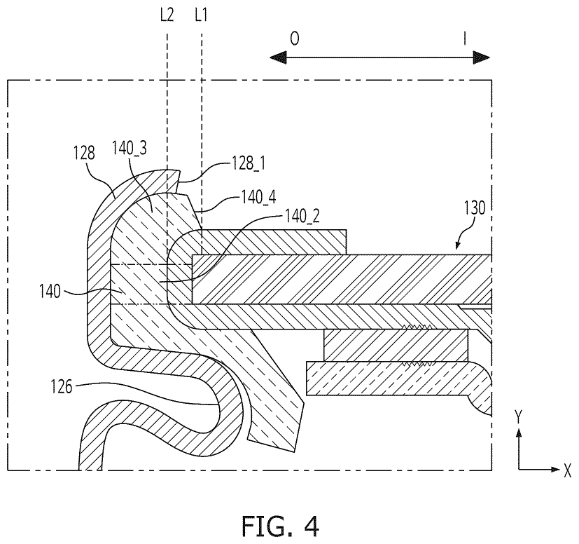

FIG. 4 is an enlarged cross-sectional view illustrating an example of a crimping portion 128 of a secondary battery according to an embodiment of the present disclosure. Hereinafter, the direction toward the center of the case of the secondary battery is defined as the inner side I of the radial direction O-I of the case, and the opposite direction thereof is defined as the outer side O of the radial direction O-I of the case. Hereinafter with reference to FIG. 4, redundant description of the components that are the same or substantially the same as those described above with reference to FIGS. 2 and 3 may not be repeated.

According to an embodiment, as the crimping portion 128 is bent, the end portion of the gasket 140 in contact with the crimping portion 128 may also be bent toward the inner side I of the radial direction O-I of the case. The gasket 140 may include the vertical portion 140_2 that contacts the side of the cap assembly, and the bent portion 140_3 that extends from the vertical portion 140_2. The gasket 140 shown in FIG. 4 may not include a horizontal portion (e.g., the horizontal portion 140_1) compared to the gasket shown in FIG. 2.

According to an embodiment, the end 128_1 of the crimping portion 128 may be located outward further from the position L1 of the end of the bent portion 140_3, and inward from the position L2 of the inner circumferential surface of the vertical portion 1402, based on the radial direction O-I of the case. The end 140_4 of the gasket 140 may protrude further than the end 128_1 of the crimping portion 128, with respect to the inner side I of the radial direction O-I of the case.

According to an embodiment, the end 140_4 of the gasket 140 may protrude toward the inner side I of the radial direction O-I of the case with a downward extension (e.g., in the −Y axis direction). As shown in FIG. 4, based on the cross-section of the gasket 140 cut along the vertical direction (e.g., the Y-axis direction), the end 140_4 of the gasket 140 may have a straight line shape that leans toward the inner side I of the radial direction O-I of the case with a downward extension (e.g., in the −Y-axis direction), but the present disclosure is not limited thereto. For example, based on the cross-section of the gasket 140 cut along the vertical direction (e.g., the Y-axis direction), the end 140_4 of the gasket 140 may have a curved shape (e.g., an arbitrary or predetermined curved shape) that deviates or varies toward the inner side I of the radial direction O-I of the case with a downward extension (e.g., in the −Y-axis direction).

The length of the gasket 140 may be smaller than that of the gasket shown in FIG. 3, and a short-circuit due to a contact between the end 128_1 of the crimping portion 128 and the cap assembly 130 may be effectively prevented.

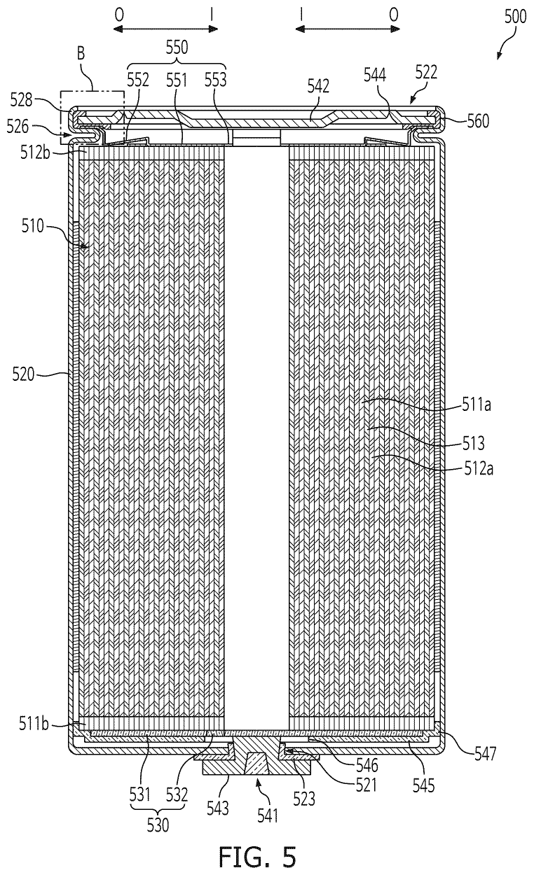

FIG. 5 is a cross-sectional view illustrating an example of a secondary battery 500 according to an embodiment of the present disclosure.

Referring to FIG. 5, the secondary battery 500 according to an embodiment of the present disclosure may include an electrode assembly 510 that performs charging and discharging, a case 520 accommodating the electrode assembly 510, a first current collector plate 530 connected to the electrode assembly 510, a second current collector plate 550, an electrode terminal 541, a cap assembly 542, and a gasket 560. FIG. 5 illustrates that the cap assembly 542 is disposed on the upper portion of the secondary battery 500, and the electrode terminal 541 is disposed at the bottom of the secondary battery 500, but the present disclosure is not limited thereto. Depending on a usage environment or requirements of the secondary battery 500, the cap assembly 542 and electrode terminal 541 may be disposed at the bottom and the top of the secondary battery 500, respectively.

The electrode assembly 510 may be formed into a cylindrical jelly roll shape with a hollow core by winding first electrodes 511a and 511 b, a separator 513, and second electrodes 512a and 512b. The first electrodes 511a and 511b and the second electrodes 512a and 512b may include coating portions 511a and 512a where an active material is applied to both sides (e.g., opposite sides) of a substrate formed as a thin metal plate, and non-coated portions 511b and 512b where the substrate is exposed without an active material being applied.

The first electrodes 511a and 511b may be electrodes corresponding to a positive electrode or a negative electrode in the secondary battery 500. The second electrodes 512a and 512b may be electrodes corresponding to opposite polarities of that of the first electrodes 511a and 511 b. For example, when the first electrodes 511a and 511b are the positive electrodes, the second electrodes 512a and 512b may be the negative electrodes. On the other hand, when the first electrodes 511a and 511b are the negative electrodes, the second electrodes 512a and 512b may be the positive electrodes.

For example, the first electrodes 511a and 511b may form positive electrodes by coating a positive electrode active material onto an aluminum (Al) substrate, and the second electrodes 512a and 512b may form negative electrodes by coating a negative electrode active material onto a copper (Cu) substrate. The non-coated portion 511b of the first electrode and the non-coated portion 512b of the second electrode may be respectively provided at both ends (e.g., opposite ends) along the winding axis direction of the electrode assembly 510, but the electrode terminals 541 and the case 520 having different polarities from each other may be provided together in the same direction as each other. The cap assembly 542 may be located on an opposite side of the electrode terminal 541.

The case 520 may be formed into a cylindrical shape to accommodate the electrode assembly 510, and the electrode terminals 541 and cap assembly 542 may be provided at opposite axial ends of the case 520 from each other.

The electrode terminal 541 may be connected to the first electrodes 511a and 511b via the first current collector plate 530 through a rivet 543, and the case 520 may be connected to the second electrodes 512a and 512b via the second current collector plate 550. The cap assembly 542 may be electrically spaced apart from the second current collector plate 550 and the case 520, and may not have a polarity.

The electrode terminal 541 connected to the first electrodes 511a and 511b of the electrode assembly 510 inserted into the case 520 from the outside may be provided on one side of the case. The case 520 may have a through hole 521 that is partially open on one side.

For example, the electrode terminal 541 may be provided in the through hole 521 of the case 520 as in a rivet structure. The electrode terminal 541 may be connected to the rivet 543. One end of the rivet 543 may be welded and connected to the first current collector plate 530, and may be disposed to pass through the through hole 521. The electrode terminal 541 may be connected to the rivet 543, and may be disposed on the outer side of the case 520. The electrode terminal 541 may be formed to protrude from the outer surface of the case 520 around the through hole 521, and may be used as a positive electrode terminal. In this case, the first current collector plate 530 may be a positive electrode current collector plate.

In this case, the first current collector plate 530 may be electrically connected to the non-coated portion 511b of the first electrode through the rivet 543 to be electrically and mechanically connected to the electrode terminal 541. The first current collector plate 530 may be electrically connected to the electrode terminal 541 in a suitable structure that contacts most of the non-coated portion 511b of the first electrode to reduce a resistance. The rivet 543 included in the electrode terminal 541 may form a sealed structure against the electrolyte by interposing an insulating member 523 in the through hole 521, which maintains an insulating state with the case 520.

The insulating member 523 may be made of a polymer including an ethylene propylene rubber (EPDM), polypropylene (PP), polyimide (PI), polyethylene terephthalate (PET), polycarbonate (PC), or a combination thereof.

As another example, the insulating member 523 may be made of a ceramic material including an epoxy resin, alumina (Al₂O₃), zirconia (ZrO₂), an aramid fiber, nomex, or a combination thereof. However, the material of the insulating member 523 is not limited to the materials described above, and may include various suitable materials having excellent plasticity and insulation properties depending on a selection.

According to an embodiment, the first current collector plate 530 may include a metal plate 531 including at least one bridge 532. For example, the first current collector plate 530 may be made of one or more conductive metals, such as nickel, aluminum, copper, silver, zinc, tin, one or more stainless steel materials (e.g., SUS), a nickel-plated steel, or a combination (an alloy) thereof. The metal plate 531 and the bridge 532 that may form the first current collector plate 530 may be integrally made of the same material as each other, but the present disclosure is not limited thereto.

The bridge 532 of the first current collector plate 530 may rupture when a current equal to or greater than a value (e.g., a threshold or predetermined value) flows. For example, the bridge 532 may function as part of a circuit through which a current flows under normal conditions, but when a current exceeding the threshold amount flows, the bridge 532 may function as a fuse that melts by generated heat to block a circuit.

An insulating tape 545 may be attached to one side of the first current collector plate 530. The insulating tape 545 may be interposed between the first current collector plate 530 and the case 520, or between the non-coated portion 511b of the first electrode and the case 520, to electrically insulate each component. According to an embodiment, the central portion of the insulating tape 545 may include a perforation 546 that corresponds to the shape of the rivet 543 so that the rivet 543 may contact the first current collector plate 530. The insulating tape 545 may also include a side wall portion 547 to surround (e.g., around a periphery of) a part of the electrode assembly 510.

Additionally, the case 520 may include an opening portion 522 that is completely open to allow the electrode assembly 510 to be inserted into another side. The cap assembly 542 may seal the opening portion 522 after insertion of the electrode assembly 510 into the case 520, and may be electrically separated from the case 520.

According to an embodiment, the case 520 may include a beading portion 526 and a crimping portion 528. The beading portion 526 may be formed by the case 520 that is recessed toward the inner side I in the radial direction O-I of the case 520, and may support the cap assembly 542 and the gasket 560. For example, the beading portion 526 may suppress the movement of the electrode assembly 510 within the case 520, and may facilitate the mounting of the gasket 560 and the cap assembly 542. The crimping portion 528 may be formed by bending an end portion of the case 520 toward the inner side I of the radial direction θ-1. The crimping portion 528 may press an edge of the cap assembly 542 through the gasket 560, thereby firmly fixing the cap assembly 542.

The second current collector plate 550 may be electrically connected to the non-coated portion 512b of the second electrode to be electrically connected to the case 520. The second current collector plate 550 may be connected to the case 520 in a structure that contacts most of the non-coated portion 512b of the second electrode to reduce a resistance.

The second current collector plate 550 may include a flat portion 551 welded to the non-coated portion 512b of the second electrode, and a wing portion 552 formed adjacent to the flat portion 551 and welded to the beading portion 526. The second current collector plate 550 may be formed by cutting and bending a circular plate, and may have a plurality of flat portions 551 and a plurality of wing portions 552 alternately disposed along the circumferential direction. According to an embodiment, the wing portion 552 may be formed by repeatedly bending the electrode assembly 510 in the axial direction (e.g., the upward direction) and in the radial direction (e.g., the outward direction).

According to an embodiment, when the non-coated portion 512b of the second electrode and the flat portion 551 of the second current collector plate 550 are welded together, the flat portion 551 may form a welding line in the radial direction of the second current collector plate 550. Therefore, the flat portion 551 may be uniformly connected along the circumferential direction in the area of the non-coated portion 512b of the second electrode, and the wing portion 552 may be uniformly connected along the circumferential direction in the area of the beading portion 526. Therefore, a uniform current may flow along the circumferential direction throughout the entire area of the beading portion 526 of the case 520 from the non-coated portion 512b of the second electrode. The second current collector plate 550 may have a hole 553 at its center to absorb and mitigate deformation that may be caused by welding between the flat portion 551 and the non-coated portion 512b of the second electrode, and vibrations and impacts that may be transmitted between the wing portion 552 and the flat portion 551. The hole 553 may have a suitable size within a suitable range that allows absorption of vibrations and impacts without increasing an electrical resistance between the wing portion 552 and the flat portion 551.

According to an embodiment, the cap assembly 542 may include a vent plate and a cap-down. The vent plate may be electrically separated from the second current collector plate 550. In this case, the case 520 may be connected to the second current collector plate 550 to function as a negative electrode terminal, and the second current collector plate 550 may be a negative electrode current collector plate. The cap-down may be disposed under the vent plate, and may be electrically connected to the second current collector plate 550. However, depending on the design, the components of the cap assembly 542 may vary, and may not be limited to the structure illustrated in FIG. 5 and described above. For example, the cap assembly 542 may consist solely of the vent plate, in which case the vent plate may be directly connected to the second current collector plate 550. As another example, the cap assembly 542 may further include a cap-up at the top of the vent plate.

According to an embodiment, the vent plate may include a notch 544. When an abnormal event occurs in the secondary battery 500, the notch 544 may be cut to release the internal pressure of the secondary battery 500 to the outside, thereby preventing or substantially preventing a secondary explosion. In more detail, the notch 544 may be easily cut when subjected to a concentrated internal pressure during an abnormal event. The notch 544 may be formed over the entire area along the circumferential direction of the cap assembly 542, or may be formed as a plurality of notches that are spaced apart from each other at a suitable distance (e.g., a predetermined distance).

The gasket 560 may be interposed between the second current collector plate 550 and the cap assembly 542, between the second current collector plate 550 and the case 520, and between the beading portion 526 and the crimping portion 528. The gasket 560 may also form a sealing structure against the electrolyte between the second current collector plate 550 and the opening portion 522 of the case 520.

For example, the gasket 560 may be made of polymer materials, such as polyvinyl chloride (PVC), polytetrafluoroethylene (PTFE or Teflon), polyethylene (PE), an epoxy resin, silicone, polyvinylidene fluoride (PVDF), polypropylene (PP), polyacrylonitrile (PAN), or polyethylene oxide (PEO), or ceramics. However, the gasket 560 is not limited thereto, and may correspond to any suitable compound used as an insulating material as would be understood by those having ordinary skill in the art.

The secondary battery 500 according to an embodiment of the present disclosure may be applied to automobiles, mobile phones, and/or various suitable forms of electrical devices, but the present disclosure is not limited thereto.

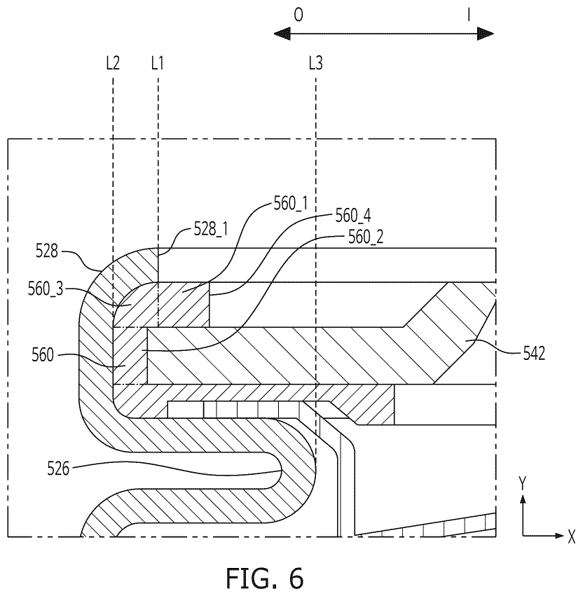

FIG. 6 is an enlarged cross-sectional view illustrating an example of a crimping portion 528 for a secondary battery according to an embodiment of the present disclosure. FIG. 6 is an enlarged cross-sectional view of the area B in FIG. 5. Hereinafter, the direction toward the center of the case of the secondary battery is defined as the inner side I of the radial direction O-I of the case, and the opposite direction thereof is defined as the outer side O of the radial direction O-I of the case.

The case of the secondary battery may include the beading portion 526 and the crimping portion 528 for mounting the cap assembly 542. The crimping portion 528 may be bent toward the inner side I of the radial direction O-I of the case, thereby press-fitting (e.g., pressing and fixing) the cap assembly 542 and the gasket 560.

According to an embodiment, an end 528_1 of the crimping portion 528 may be bent inward toward a center of the case. As the crimping portion 528 is bent, the end portion of the gasket 560 in contact with the crimping portion 528 may also be bent inward toward the inner side I of the radial direction O-I of the case. As the crimping portion 528 is bent, the gasket 560 may be closely attached to the cap assembly 542 to seal the case.

According to an embodiment, the end 528_1 of the crimping portion 528 may be bent to have a radius of curvature (e.g., a predetermined radius of curvature). The end 528_1 of the crimping portion 528 may be part of a curved line with respect to the cross-section of the secondary battery taken along the vertical direction (e.g., the Y-axis direction). The end 528_1 of the crimping portion 528 may be bent to have a single radius of curvature, but the present disclosure is not limited thereto. In addition, the radius of curvature of the end 528_1 of the crimping portion 528 may be less than 1.0 mm, but the present disclosure is not limited thereto.

According to an embodiment, the end 528_1 of the crimping portion 528 may be bent toward the inner side I of the radial direction O-I of the case. The end 528_1 of the crimping portion 528 may extend toward the radial direction O-I of the case, and may be a part of a curved line having a radius of curvature.

The gasket 560 may include a horizontal portion 560_1 in contact with the edge of the top of the cap assembly 542, a vertical portion 560_2 that contacts the side of the cap assembly 542, and a bent portion 560_3 that connects the horizontal portion 560_1 to the vertical portion 560_2.

According to an embodiment, the position of the end 528_1 of the crimping portion 528 may correspond to a position L1 where the bent portion 560_3 and the horizontal portion 560_1 contact each other, based on the radial direction O-I of the case. In this case, the position of the end 528_1 of the crimping portion 528 may be disposed inward further than the position L2 of the inner circumferential surface of the vertical portion 560_2, based on the radial direction O-I of the case.

According to an embodiment, the beading portion 526 may be formed under the crimping portion 528, and may be recessed toward the inner side I in the radial direction O-I of the case. In this case, the beading portion 526 may protrude further than the end 528_1 of the crimping portion 528 toward the inner side I of the radial direction O-I of the case. The position of the end 528_1 of the crimping portion 528 may be located outward further than the position L3 of the inner surface of the beading portion 526 based on the radial direction O-I of the case.

According to an embodiment, the position of the end 560_4 of the gasket 560 may correspond to the position of the end 528_1 of the crimping portion 528, or may be located toward the inner side I more than the position of the end 528_1 of the crimping portion 528 with respect to the radial direction O-I of the case. Additionally, the end 560_4 of the gasket 560 may protrude toward the inner side I of the radial direction O-I of the case with a downward extension (e.g., in the −Y axis direction), but the present disclosure is not limited thereto.

FIG. 6 illustrates that the end 528_1 of the crimping portion 528 extends to the position L1 where the bent portion 560_3 and the horizontal portion 560_1 contact each other, but the present disclosure is not limited thereto. For example, the end 528_1 of the crimping portion 528 may extend further past the position L1 where the bent portion 560_3 and the horizontal portion 560_1 contact each other by maintaining the curvature radius. As an example, when the end 528_1 of the crimping portion 528 extends in the direction from L1 to L3, the end 528_1 may extend toward a direction parallel to or substantially parallel to the radial direction O-I of the case (e.g., the X-axis direction) and a downward direction (e.g., the −Y-axis direction) by maintaining the curvature radius.

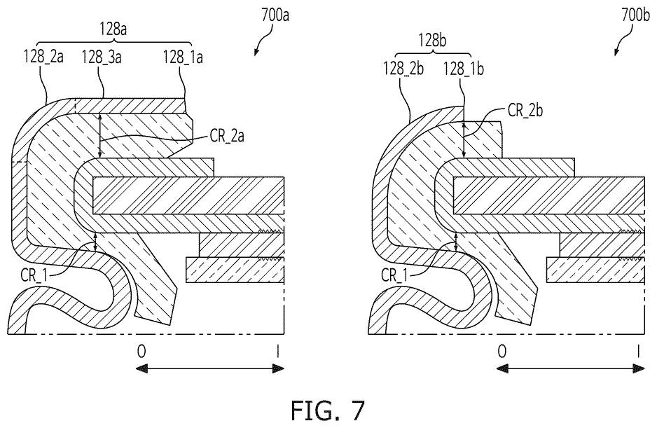

FIG. 7 is cross-sectional views illustrating a comparison of a crimping portion 128b of a secondary battery according to an embodiment of the present disclosure and a crimping portion 128a of a secondary battery according to a comparative example. In FIG. 7, a first example 700a is an enlarged cross-sectional view illustrating a part of the secondary battery according to the comparative example, and a second example 700b is an enlarged cross-sectional view illustrating a part of the secondary battery (e.g., the secondary battery 100 of FIG. 1, the secondary battery 500 of FIG. 5, or the like) according to an embodiment of the present disclosure.

Referring to the first example 700a, the crimping portion 128a may be bent toward the inner side I of the radial direction O-I of the case. The crimping portion 128a may include a straight line portion 128_3a bent toward the inner side I of the radial direction O-I of the case parallel to or substantially parallel to the direction of extension of the cap assembly, and a curved line portion 128_2a connected to and bent from the straight line portion 128_3a. Accordingly, the end 128_1a of the crimping portion 128a may be located on the straight line portion 128_3a. The end 128_1a of the crimping portion 128a may form a part of the straight line.

The deformation pressure/rupture pressure of the crimping portion 128a may be adjusted according to the position of the end 128_1a of the crimping portion 128a. For example, the deformation pressure/rupture pressure of the crimping portion 128a may increase as the extended length of the straight line portion 128_3a of the crimping portion 128a increases, and as the radius of curvature of the curved line portion 128_2a of the crimping portion 128a decreases. When the crimping portion 128a includes the straight line portion 128_3a, the deformation pressure/rupture pressure of the crimping portion 128a may be greater than the rupture pressure of the vent plate.

Referring to the second example 700b, the crimping portion 128b may be bent toward the inner side I of the radial direction O-I the case. The crimping portion 128b may include the curved line portion 128_2b bent toward the inner side I of the radial direction O-I of the case to have a radius of curvature (e.g., a predetermined radius of curvature). The crimping portion 128b of the second example 700b may have a structure in which the straight line portion 128_3a is omitted compared to the crimping portion 128a of the first example 700a. Accordingly, the end 128_1b of the crimping portion 128b may be located in the curved line portion 128_2b.

According to an embodiment, the deformation pressure/rupture pressure of the crimping portion 128b may be adjusted according to the position of the end 128_1b of the crimping portion 128b. For example, the deformation pressure/rupture pressure of the crimping portion 128b may increase as the radius of curvature of the curved line portion 128_2b of the crimping portion 128b decreases. When the crimping portion 128b includes (e.g., only includes) the curved line portion 128_2b without a straight line portion, the deformation pressure/rupture pressure of the crimping portion 128a may correspond to or substantially correspond to the rupture pressure of the vent plate.

Referring to the first example 700a and the second example 700b, as the crimping portion 128a of the first example 700a includes the straight line portion 128_3a, an upper compression ratio CR_2a of the gasket in the first example 700a may be greater than an upper compression ratio CR_2b of the gasket in the second example 700b. The upper compression ratios CR_2a and CR_2b may refer to the compression ratios of the gasket between the end portions of the crimping portions 128a and 128b and the vent plate.

According to an embodiment, the sealing performance of the case by the gasket may be managed by a lower compression ratio CR_1 of the gasket. The lower compression ratio CR_1 of the gasket may refer to the compression ratio of the gasket between the beading portion and the vent plate. The lower compression ratio CR_1 of the gasket may be maintained at approximately 55%, but the present disclosure is not limited thereto. Accordingly, even though the upper compression ratio CR_2b of the gasket in the second example 700b decreases, the sealing performance of the case provided by the gasket may not be affected.

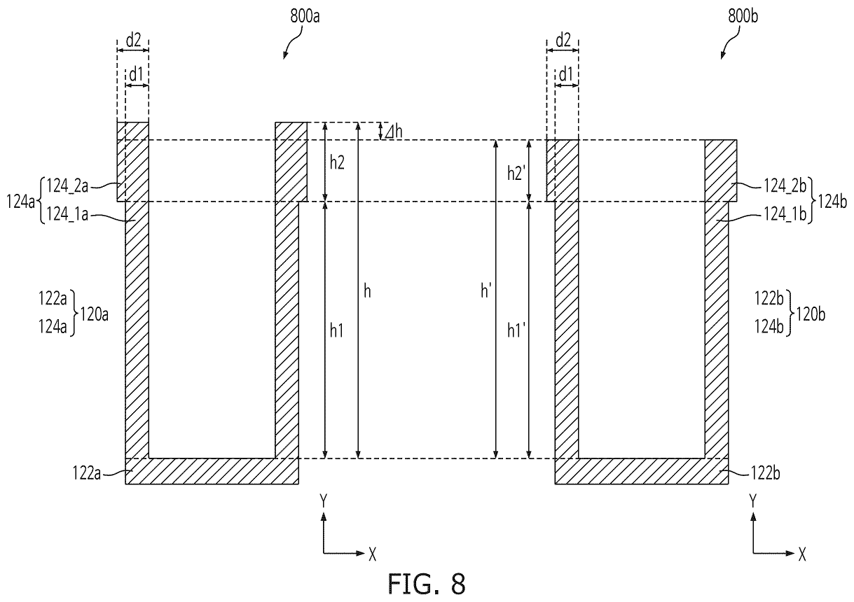

Therefore, the deformation pressure/rupture pressure of the crimping portion 128b may be adjusted by reducing the length of the end portion of the crimping portion 128b without affecting the sealing performance by the gasket. Accordingly, the deformation pressure/rupture pressure of the crimping portion 128b may be designed to correspond to or substantially correspond to the rupture pressure of the vent plate. Some examples of the deformation pressure/rupture pressure of the crimping portion 128b will be described in more detail below with reference to FIG. 8.

FIG. 8 is a schematic view illustrating a comparison of a case 120b of a secondary battery according to an embodiment of the present disclosure and a case 120a of a secondary battery according to a comparative example. A first example 800a is a vertical cross-sectional view illustrating the case 120a of the secondary battery according to a comparative example, and a second example 800b is a vertical cross-sectional view illustrating the case 120b of the secondary battery according to an embodiment of the present disclosure.

Referring to the first example 800a and the second example 800b, the cases 120a and 120b may include bottom portions 122a and 122b, and side wall portions 124a and 124b connected to the bottom portions 122a and 122b. The side wall portions 124a and 124b may include first cylindrical portions 124_1a and 124_1b connected to the bottom portions 122a and 122b, and second cylindrical portions 124_2a and 124_2b connected to the first cylindrical portions 124_1a and 124_1b and located at end portions of the side wall portions 124a and 124b. The crimping portion may be formed by bending the second cylindrical portions 124_2a and 124_2b.

According to an embodiment, a thickness d2 of the second cylindrical portions 124_2a and 124_2b may be greater than a thickness d1 of the first cylindrical portions 124_1a and 124_1b. For example, the thickness d1 of the first cylindrical portions 124_1a and 124_1b may be approximately 0.22 mm, and the thickness d2 of the second cylindrical portions 124_2a and 124_2b may be approximately 0.25 mm, but the present disclosure is not limited thereto.

According to an embodiment, a height h2′ of the second cylindrical portion 124_2b according to the second example 800b may be 9% to 14% of a height of the side wall portion 124b. For example, the height h2′ of the second cylindrical portion 124_2b may be 10% to 13% of the height of the side wall portion 124b. According to another example, the height h2′ of the second cylindrical portion 124_2b may be 11% to 14% of the height of the side wall portion 124b. The height h2′ of the second cylindrical portion 124_2b with respect to the height of the side wall portion 124b may vary within a suitable range (e.g., a predetermined range) depending on the design.

According to an embodiment, the height h2′ of the second cylindrical portion 124_2b may be 6.5 mm to 9.0 mm. For example, the height h2′ of the second cylindrical portion 124_2b may be 7.6 mm to 8.0 mm, but the present disclosure is not limited thereto. The height h2′ of the second cylindrical portion 124_2b may vary within a suitable range (e.g., a predetermined range) depending on the design.

According to an embodiment, a height h′ of the side wall portion 124a of the case 120b according to the second example 800b may be smaller than the height h of the side wall portion 124b of the case 120a according to the first example 800a. In this case, the height h2′ of the second cylindrical portion 124_2b of the case 120b according to the second example 800b may be reduced by a suitable length (e.g., a predetermined length) compared to the height h2 of the second cylindrical portion 124_2a of the case 120a according to the first example 800a. The height h1 of the first cylindrical portion 124_1a of the case 120a according to the first example 800a and the height h1′ of the first cylindrical portion 124_1b of the case 120b according to the second example 800b may be the same or substantially the same as each other, but only the heights of the second cylindrical portions 124_2a and 124_2b where the crimping portion is formed may differ from each other.

According to an embodiment, the height h2′ of the second cylindrical portion 124_2b according to the second example 800b may be 78% to 85% of the height h2 of the second cylindrical portion 124_2a according to the first example 800a. In this case, a shortened length Δh of the second cylindrical portion 124_2b may be 15% to 22% of the height h2 of the second cylindrical portion 124_2a, but the present disclosure is not limited thereto. For example, the height h2′ of the second cylindrical portion 124_2b may be 80% to 83% of the height h2 of the second cylindrical portion 124_2a, in which case the shortened length Δh of the second cylindrical portion 124_2b may be 17% to 20% of the height h2 of the second cylindrical portion 124_2a. The shortened length Δh of the second cylindrical portion 124_2b with respect to the height h2 of the first cylindrical portion 124_2a may vary within a suitable range (e.g., a predetermined range) depending on the design.

According to an embodiment, as the length of the second cylindrical portion 124_2b is reduced, the crimping portion where the second cylindrical portion 124_2b is bent may include only a curved line portion (e.g., the curved line portion 128_2b in FIG. 7). As the length of the second cylindrical portion 124_2b is reduced, the end of the crimping portion may be designed to be located at the curved line portion. Accordingly, the deformation pressure/rupture pressure of the crimping portion may be adjusted.

Table 1 below shows experimental results of measuring the deformation pressure/rupture pressure of the crimping portion according to the length of the second cylindrical portion at both a room temperature (e.g., 23° C. to 24° C.) and a high temperature (e.g., 90° C. to 100° C.) with oil being injected into the case. Additionally, the deformation pressure/rupture pressure of the crimping portion measured straight before a deformation/rupture, with gas (e.g., nitrogen gas) injected into the case, is shown as a reference value. The experimental results below are measured for a case with the thickness of second cylindrical portion of 0.25 mm. The cases according to a comparative example and first to third embodiments are all designed with the height of the first cylindrical portion of 64.2 mm.

TABLE 1

| | | | Deformation Pressure/Rupture Pressure | | |
|---|---|---|---|---|---|
| | | | (kgf/cm²/kgf/cm²) | | |
| | h2′ | Δh | Room | High | |
| | (mm) | (mm) | Temperature | Temperature | Reference |
| Comparison | 9.6 | 0 | 73 | 63 | 25-30 |
| Example | | (0%) | | | |
| First | 7.9 | 1.70 | 42 | 36 | 29 |
| Embodiment | | (17%) | | | |
| Second | 7.9 | 1.70 | 40 | 35 | 27 |
| Embodiment | | (17%) | | | |
| Example 3 | 7.65 | 1.95 | 35 | 25 | 25 |
| | | (20%) | | | |

In Table 1, h2′ denotes the height of the second cylindrical portion, and Δh denotes a length smaller than the height of the second cylindrical portion in the comparative example. The case according to the comparative example may be substantially identical to the case 120a according to the first example 800a described above with reference to FIG. 8. The cases of the first to third embodiments may correspond to some embodiments of the case 120b according to the second example 800b described above with reference to FIG. 8. In more detail, the case according to the first embodiment may be substantially identical to the case of the secondary battery shown in FIG. 2, the case according to the second embodiment may be substantially identical to the case of the secondary battery shown in FIG. 3, and the case according to the third embodiment may be substantially identical to the case of the secondary battery shown in FIG. 4.

Referring to Table 1, as the height h2′ of a second cylindrical portion 124_2b is reduced, the deformation pressure/rupture pressure of the crimping portion may be designed to be 25 kgf/cm² or greater and 42 kgf/cm² or less. Accordingly, the range of deformation pressure/rupture pressure of the crimping portion may correspond to the range of the rupture pressure of the vent plate to a predetermined extent.

According to some embodiments, when gas is generated inside the case of the secondary battery and the internal pressure of the case reaches the rupture pressure of the vent plate, the crimping portion may deform and rupture along with the vent plate, so that the internal gas may be easily discharged.

FIG. 9 is a schematic view illustrating a comparison of examples of discharging gas from a secondary battery 1001b according to an embodiment of the present disclosure and a secondary battery 100_1a according to a comparative example. A first example 900a illustrates an example of gas being released from inside the secondary battery 100_1a according to the comparative example, and a second example 900b illustrates an example of gas being released from inside the secondary battery 100_1b according to an embodiment of the present disclosure.

The first example 900a is an example of the secondary battery 100_1a where the deformation pressure/rupture pressure of the crimping portion is greater than the rupture pressure of the vent plate. Referring to the first example 900a, when gas is generated inside the case of the secondary battery 100_1a and the internal pressure of the case exceeds a threshold pressure (e.g., a predetermined threshold pressure), a vent plate 134a may rupture, and the internal gas may be discharged. However, when the vent plate 134 is blocked by foreign substances and the like released with the internal gas, and the internal gas is not properly discharged through the vent plate 134, the side wall portion of the case may be opened, which may allow the gas to be discharged through the side wall portion. In this case, a secondary battery 100_2a adjacent to the secondary battery 100_1a may be affected, thereby potentially causing a multi-cell thermal runaway phenomenon.

The second example 900b shows the secondary battery 100_1b where the deformation pressure/rupture pressure of the crimping portion 128 corresponds to or substantially corresponds to the rupture pressure of a vent plate 134b. Referring to the second example 900b, when gas is generated inside the case of the secondary battery 1001b and the internal pressure of the case reaches the rupture pressure of the vent plate 134b, the crimping portion 128 may deform/rupture together. In this case, a gap may be formed between the cap assembly and the crimping portion 128, allowing gas to be discharged in the upward direction of the secondary battery 100_1b (e.g., toward the cap assembly side). In this case, an impact on a secondary battery 100_2b adjacent to the secondary battery 100_1b may be minimized or reduced.

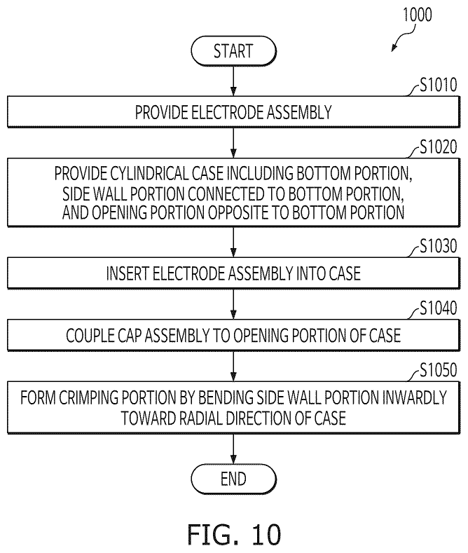

FIG. 10 is a flowchart illustrating a method for manufacturing a secondary battery 1000 according to an embodiment of the present disclosure.

Referring to FIG. 10, a method for manufacturing a secondary battery 1000 may start, and an electrode assembly may be provided (S1010). A cylindrical including a bottom portion, a side wall portion connected to the bottom portion, and an opening portion opposite to the bottom portion may be provided (S1020). Subsequently, the electrode assembly may be inserted into the case (S1030).

The cap assembly may be coupled to the opening portion of the case (S1040). A gasket may be disposed between the cap assembly and the case. The side wall portion of the case may include a beading portion recessed inwardly toward the radial direction of the case, and the beading portion may support the cap assembly and the gasket.

According to an embodiment, the cap assembly may include a vent plate. The cap assembly may include a cap-down disposed under the vent plate. Additionally, the cap assembly may include a cap-up disposed above the vent plate. The cap-up may surround (e.g., around a periphery of) the vent plate, but the present disclosure is not limited thereto. The configuration of the cap assembly is not limited thereto, and may be variously modified depending on the design.

A crimping portion may be formed by bending the side wall portion inwardly toward the radial direction of the case (S1050), and the method 1000 may end. For example, the end of the crimping portion may be bent inwardly toward the radial direction of the case to have a radius of curvature (e.g., a predetermined radius of curvature). The radius of curvature of the end of the crimping portion may be less than 1.0 mm, but the present disclosure is not limited thereto. The crimping portion may be formed on top of the beading portion, and the beading portion may protrude further than the end of the crimping portion inwardly toward the radial direction of the case, but the present disclosure is not limited thereto.

According to an embodiment, the side wall portion of the case may include a first cylindrical portion connected to the bottom portion, and a second cylindrical portion connected to the first cylindrical portion and disposed at the end portion of the side wall portion. The crimping portion may be formed in the second cylindrical portion. The thickness of the second cylindrical portion may be greater than that of the first cylindrical portion. Before the side wall portion is bent, the height of the second cylindrical portion may be 9% to 14% of the height of the side wall portion, but the present disclosure is not limited thereto. Additionally, before the side wall portion is bent, the height of the second cylindrical portion may be 6.5 mm or greater and 9.0 mm or less. However, the height of the second cylindrical portion is not limited thereto, and may vary depending on the kind of secondary battery.

According to an embodiment, the gasket may include a horizontal portion in contact with the top of the cap assembly, a vertical portion in contact with the side of the cap assembly, and a bent portion that connects the horizontal and vertical portions.

According to an embodiment, the end portion of the gasket may be bent inwardly toward the radial direction of the case as the crimping portion is bent. In this case, the position of the end of the gasket may correspond to the position of the end of the crimping portion with respect to the radial direction of the case. According to another embodiment, the position of the end of the gasket may be located inwardly further than the position of the end of the crimping portion, based on the radial direction of the case. According to another embodiment, the position of the end of the gasket may correspond to the position where the bent portion and the horizontal portion of the gasket contact each other, based on the radial direction of the case.

According to an embodiment, the position of the end of the crimping portion may correspond to the position where the bent portion and the horizontal portion of the gasket contact each other, based on the radial direction of the case. As another embodiment, the end of the crimping portion may be located further outward than the position where the bent portion and the horizontal portion of the gasket contact each other, and further inward than the inner surface of the vertical portion with respect to the radial direction of the case.

According to an embodiment, when the pressure inside the case exceeds a threshold pressure (e.g., a predetermined threshold pressure), the position of the end of the crimping portion may change from the inner side to the outer side in the radial direction of the case due to the pressure inside the case. The threshold pressure may correspond to the rupture pressure of the vent plate included in the cap assembly. The threshold pressure may be 25 kgf/cm² or greater and 42 kgf/cm² or less, but the present disclosure is not limited thereto.

However, the present disclosure is not limited to the flow chart described above with reference to FIG. 10. For example, one or more operations may be added/changed/deleted, the order of one or more operations may be changed, and/or one or more operations may be performed concurrently (e.g., simultaneously or substantially simultaneously) with each other.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

DESCRIPTION OF SOME REFERENCE SYMBOLS

| | |
|---|---|
| 100: Secondary Battery | 110: Electrode Assembly |
| 112: First Electrode | 113: Second Electrode |
| 114: Separator | 115: First Lead Tab |
| 116: Second Lead Tab | 120: Case |
| 122: Bottom | 124: Side Wall Portion |
| 126: Beading Portion | 128: Crimping Portion |
| 130: Cap Assembly | 132: Cap-up |
| 134: Vent Plate | 136: Insulator |
| 138: Cap-down | 140: Gasket |
| 150: Insulating Plate | |

What is claimed is:

1. A secondary battery comprising:
an electrode assembly;
a cylindrical case accommodating the electrode assembly, and comprising a bottom portion, a side wall portion connected to the bottom portion, and an opening portion opposite to the bottom portion;
a cap assembly coupled to the opening portion of the case; and
a gasket between the cap assembly and the case,
wherein the side wall portion comprises a crimping portion bent radially inward to press and fix the cap assembly and the gasket, and
wherein an end of the crimping portion that is bent radially inward has a radius of curvature.

2. The secondary battery as claimed in claim 1, wherein the gasket comprises:
a horizontal portion in contact with a top of the cap assembly;
a vertical portion in contact with a side of the cap assembly; and
a bent portion connecting the horizontal portion to the vertical portion,
wherein a position of the end of the crimping portion corresponds to a position where the bent portion and the horizontal portion contact each other with respect to a radial direction of the case.

3. The secondary battery as claimed in claim 1, wherein the gasket comprises:
a horizontal portion in contact with a top of the cap assembly;
a vertical portion in contact with a side of the cap assembly; and
a bent portion connecting the horizontal portion to the vertical portion,
wherein, with respect to a radial direction of the case, the end of the crimping portion is radially outward further than a position where the bent portion contacts the horizontal portion, and is radially inward further than an inner circumferential surface of the vertical portion.

4. The secondary battery as claimed in claim 1, wherein an end portion of the gasket in contact with the crimping portion is bent radially inward in response to the crimping portion being bent, and
wherein a position of an end of the gasket corresponds to a position of the end of the crimping portion, or is radially inward further than the end of the crimping portion.

5. The secondary battery as claimed in claim 3, wherein an end portion of the gasket in contact with the crimping portion is bent radially inward in response to the crimping portion being bent, and
wherein a position of an end of the gasket corresponds to a position where the bent portion contacts the horizontal portion with respect to the radial direction.

6. The secondary battery as claimed in claim 1, wherein the side wall portion further comprises:
a beading portion under the crimping portion, and recessed radially inward to support the cap assembly and the gasket, and
wherein the beading portion protrudes further radially inward than the end of the crimping portion.

7. The secondary battery as claimed in claim 1, wherein the cap assembly comprises a vent plate.

8. The secondary battery as claimed in claim 1, wherein the cap assembly comprises:
a vent plate; and
a cap-down under the vent plate.

9. The secondary battery as claimed in claim 1, wherein the cap assembly comprises:
a vent plate;
a cap-down under the vent plate; and
a cap-up at a top of the vent plate.

10. The secondary battery as claimed in claim 1, wherein a position of the end of the crimping portion is configured to change from an inner side to an outer side in a radial direction in response to an internal pressure of the case exceeding a threshold pressure.

11. The secondary battery as claimed in claim 10, wherein the cap assembly comprises a vent plate, and the threshold pressure corresponds to a rupture pressure of the vent plate.

12. The secondary battery as claimed in claim 10, wherein the threshold pressure is 25 kgf/cm² or greater and 42 kgf/cm² or less.

13. The secondary battery as claimed in claim 1, wherein the side wall portion comprises:
a first cylindrical portion connected to the bottom portion; and
a second cylindrical portion connected to the first cylindrical portion, and located at an end portion of the side wall portion,
wherein the crimping portion is located in the second cylindrical portion, and
wherein a thickness of the second cylindrical portion is greater than a thickness of the first cylindrical portion.

14. The secondary battery as claimed in claim 13, wherein a height of the second cylindrical portion is 9% to 14% of a height of the side wall portion before the side wall portion is bent.

15. The secondary battery as claimed in claim 13, wherein a height of the second cylindrical portion is 6.5 mm or greater and 9.0 mm or less before the side wall portion is bent.

16. The secondary battery as claimed in claim 1, wherein the radius of curvature of the end of the crimping portion is less than 1.0 mm.

17. A method for manufacturing a secondary battery, the method comprising:
providing an electrode assembly;
providing a cylindrical case comprising a bottom portion, a side wall portion connected to the bottom portion, and an opening portion opposite to the bottom portion;
inserting the electrode assembly into the case;
coupling a cap assembly to the opening portion of the case; and
forming a crimping portion by bending the side wall portion radially inward,
wherein an end of the crimping portion is bent radially inward to have a radius of curvature.

18. The method as claimed in claim 17, wherein the coupling comprises placing a gasket between the cap assembly and the case,
wherein an end portion of the gasket is bent radially inward in response to the crimping portion being bent, and
wherein an end of the gasket is disposed radially inward further than the end of the crimping portion.

19. The method as claimed in claim 18, wherein the gasket comprises:
a horizontal portion in contact with a top of the cap assembly;
a vertical portion in contact with a side of the cap assembly; and
a bent portion connecting the horizontal portion to the vertical portion,
wherein a position of the end of the crimping portion corresponds to a position where the bent portion contacts the horizontal portion with respect to a radial direction.

20. The method as claimed in claim 17, wherein a position of the end of the bent crimping portion changes from an inner side to an outer side in a radial direction in response to an internal pressure of the case exceeding a threshold pressure.
